(19) United States
(12) Patent Application Publication
(10) Pub. No.: US 2004/0094134 A1
(43) Pub. Date: May 20, 2004

(54) Methods and apparatus for converting internal combustion engine (ICE) vehicles to hydrogen fuel

(76) Inventors: Scott D. Redmond, San Francisco, CA (US); Christoph Pistor, Sunnyvale, CA (US)

Correspondence Address: Blakely Sokoloff Taylor & Zafman, Seventh Floor, 12400 Wilshire Boulevard, Los Angeles, CA, 90025-1030, US

(21) Appl. No.: 10/637,948

(22) Filed: Aug. 7, 2003

Related U.S. Application Data
(63) Continuation-in-part of application No. 10/178,974, filed on Jun. 25, 2002, now abandoned.
(63) Continuation-in-part of application No. PCT/US03/19950, filed on Jun. 25, 2003.

(51) Int. Cl. F02B 43/00

(52) U.S. Cl. 123/527; 123/DIG. 12

(57) ABSTRACT

The present invention concerns apparatus, kits and methods for converting ICE vehicles to run on hydrogen fuel. Certain embodiments of the invention may comprise HIPAs, hydrogen gas manifolds and/or hydrogen fuel sources. The HIPAs are designed to replace the spark plugs in internal combustion engines and may comprise a hydrogen input tap, hydrogen channel, spark producer and/or one or more feedback sensors. In some embodiments, a computer and/or CPU may electronically control the timing of hydrogen ignition. The computer or CPU may be remotely programmed by modem and telephone connection to provide highly accurate ignition and other engine parameters to optimize vehicle performance and eliminate backfiring and/or pre-ignition. The hydrogen fuel may be packaged into cassettes or other modular storage systems. Cassettes may be inserted into Decom™ units to provide hydrogen fuel to the vehicle.

### RELATED APPLICATIONS

The present application is a continuation-in-part of U.S. patent application Ser. No. 10/178,974, filed Jun. 25, 2002, and a continuation-in-part of PCT Patent Application PCT/US03/19950, “Method and Apparatus for Converting Internal Combustion Engine (ICE) Vehicles to Hydrogen Fuel” by Scott D. Redmond, filed Jun. 25, 2003.

### BACKGROUND OF THE INVENTION

1. Field of the Invention

The present invention relates to the field of hydrogen powered vehicles. More particularly, the present invention concerns methods, apparatus and kits for converting internal combustion engine (ICE) vehicles to alternative fuel sources, such as hydrogen.

2. Description of Related Art

The widespread use of fossil fuel combustion and internal combustion engine (ICE) vehicles has created significant air quality problems in most of the industrialized world. Air pollution in turn is related to numerous health and environmental problems, including serious respiratory illnesses that can result in death. A variety of alternative energy sources, such as nuclear, solar, geothermal and wind power have been proposed to supplement and/or replace fossil fuel consumption. Drawbacks exist to each of these alternative energy sources.

One of the most promising non-polluting fossil fuel alternatives is hydrogen. Hydrogen can be combined with oxygen via combustion or through fuel cell mediated redox reactions to produce heat, electrical power and/or to power vehicles. The product of this reaction—water—is non-polluting and can be recycled to regenerate hydrogen and oxygen. A variety of hydrogen fuel systems for powering vehicles have been proposed, including liquified hydrogen, compressed hydrogen gas, metal hydride storage systems, hydride slurries, carbon nanotubes, doped alanate compositions and others. Hydrogen powered vehicles are being developed by most of the major automobile manufacturers in the world, including General Motors, Daimler-Benz, Ford, Toyota, Mazda and Honda.

A major problem with conversion to a hydrogen-powered economy is what to do with the approximately 700 million existing internal combustion engine (ICE) vehicles, designed to run on gasoline, that are presently on the road. Representing an existing capital investment in the trillions of dollars, it is clear that unless existing ICE vehicles can be converted to run on hydrogen, there will a continuing long-term, very large demand for maintenance of a high-polluting hydrocarbon infrastructure. A serious need exists for apparatus, methods and kits to convert existing ICE vehicles to run on hydrogen fuel. Preferably, such kits, methods and apparatus would be relatively inexpensive, easy to install and could efficiently power existing ICE vehicles on hydrogen fuel.

### SUMMARY OF THE INVENTION

The present invention generally concerns apparatus, kits and methods for converting ICE vehicles to run on hydrogen fuel. In certain embodiments, apparatus for converting vehicles may comprise a set of HIPAs (hydrogen injection port adaptors) and a gas manifold to connect the HIPAs to a hydrogen source. The apparatus may optionally comprise a hydrogen source, such as a compressed hydrogen gas tank, a liquified hydrogen gas tank, a metal hydride, a borohydride, a hydride slurry, an alanate, a hydrocarbon reformer, carbon nanotubes or any other hydrogen source known in the art. In some embodiments, the apparatus may comprise a miniature computer (CPU) with a modem. The computer may monitor hydrogen storage and demand, control the rate of hydrogen production, control hydrogen supply to each cylinder of the engine, and regulate the timing of ignition. The computer may request and/or receive programming for the particular type of vehicle that is being converted. In certain embodiments, the timing of hydrogen ignition may be controlled in part by a timing wheel on the engine fan, the timing belt shaft or other engine part. Such a mechanical timing system may be used to supplement or replace an electronic (computer-based) timing system for control of hydrogen ignition.

In various embodiments of the invention, the HIPA is designed with a screw-threaded end that can be screwed into a standard spark plug aperture in an ICE engine. The HIPA may comprise a hydrogen input tap, a hydrogen channel, a spark producer and/or one or more sensors, such as a hydrogen chamber sensor and/or a spark area sensor. The sensors may function as part of a feedback loop with a CPU, that can adjust parameters such as hydrogen flow rate and/or ignition timing to optimize engine performance. The sensors may detect that hydrogen ignition (firing) has occurred as well as the timing and intensity of firing. The sensors may also report various operating conditions to the computer, such as engine chamber temperature, gas pressure, presence or absence of backfiring, etc. In some embodiments, the HIPA, a gas line connector, the gas tubing and/or the manifold may comprise one or more valves to prevent gas backflow from the engine to the manifold or from the manifold to the hydrogen source. The hydrogen channel may comprise one or more baffles to prevent gas backflow.

Other embodiments of the invention concern kits for converting ICE vehicles to hydrogen fuel. Such kits may comprise one or more components that may include, but are not limited to, a set of HIPAs, a gas manifold, flexible gas tubing to connect the HIPAs to the manifold, a power cable, a timing disk, a timing disk sensor, a timing disk cable, a central processing unit (CPU), a gas cable to connect the manifold to a hydrogen fuel source, a sensor cable, a backfire baffle and a shunt.

In embodiments of the invention comprising a CPU, the CPU may comprise and/or be operably coupled to a thermally insulated housing, a HIPA sensor multi-tap, an electromechanical gas flow control module, a hydrogen pressure and purity sensor, a power source, a modem with automated access firmware, an RJ phone connector (e.g., US RJ-11 connector), operating electronics and/or a DragonBall, StrongArm, Motorola or any other processing chip known in the art.

Certain embodiments of the invention concern methods for converting an ICE engine to run on hydrogen. Such methods may comprise removing the spark plugs and replacing them with HIPAs, installing a source of hydrogen fuel, installing a gas manifold to connect the HIPAs to the hydrogen fuel source and connecting the HIPAs to an ignition system. In preferred embodiments, the methods may comprise installing and/or programming a CPU to monitor engine function and to control various functions of the engine, such as the amount of hydrogen flowing to each cylinder and the timing of ignition of each cylinder. In particular embodiments, ignition timing may be regulated in part by a mechanical timing mechanism, such as a tunable or tensionable timing wheel or timing belt. The timing wheel or belt may comprise a sensor. Sensors may also be present on the HIPAs and in other locations on the vehicle, such as the hydrogen fuel source and/or the gas manifold. The subject methods may comprise adjusting the timing of ignition after installing a timing mechanism.

The subject methods may further comprise programming a CPU by a remote method, such as attaching it to a phone line and dialing a remote computer or server. Such remote programming may be used to provide accurate timing and engine setting information, specific for the make, model and/or year of the vehicle to be converted. The provision of accurate timing and engine setting information serves to reduce backfires and pre-ignitions from inaccurate timings and other causes, providing a significant advantage over any current methods of ICE vehicle conversion. Alternatively, the CPU may be preprogrammed for a set number of common vehicles, and the programming specific for a particular vehicle may be selected by identifying the vehicle type that has been converted. The subject methods may further comprise attaching various components of the converted engine, such as connecting sensor leads on the HIPA, gas manifold, fuel source and/or other components to the CPU, installing flexible tubing to connect the gas manifold to the HIPAs and installing a hydrogen gas feed from the hydrogen source to the gas manifold.

### BRIEF DESCRIPTION OF THE DRAWINGS

The following drawings form part of the present specification and are included to further demonstrate certain embodiments of the present invention. The invention may be better understood by reference to one or more of these drawings in combination with the detailed description of specific embodiments presented herein.

FIG. 1 shows an exemplary hydrogen injection port adaptor (HIPA) 100. The HIPA 100 may be screwed into a standard spark plug aperture in an internal combustion engine.

FIG. 2 illustrates an exemplary gas manifold 200 to regulate hydrogen flow from a hydrogen fuel source 210 to the engine.

FIG. 3 illustrates the components of an exemplary CPU 300 of use in the disclosed methods, apparatus and kits.

FIG. 4 shows an exemplary flow chart of a method to control engine function.

FIG. 5 illustrates an exemplary timing disk and sensor 500.

FIG. 6 shows an exemplary method and apparatus to control ignition timing.

FIG. 7 illustrates an exemplary cassette for storing hydrogen fuel.

FIG. 8 illustrates an exemplary embodiment of a hydrogen valve.

FIG. 9 illustrates an exemplary hydrogen fuel source comprising a Decom™ unit.

FIG. 10 illustrates the schematics of an exemplary hydrogen fuel source.

FIG. 11 shows an exemplary embodiment of a method for ordering, distributing and/or shipping hydrogen charged cassettes.

FIG. 12 shows an exemplary embodiment of a subsystem for controlling Decom™ unit function and hydrogen gas release.

### DESCRIPTION OF ILLUSTRATIVE EMBODIMENTS

As used herein, “a” or “an” may mean one or more than one of an item.

As used herein, “operably coupled” means that there is a functional interaction between two or more units. For example, a HIPA may be operably coupled to a gas manifold if the two are connected in such a way that hydrogen gas can flow from the manifold to the HIPA. A sensor may be operably coupled to a computer if data from the sensor may be obtained and processed by the computer.

As used herein, “HIPA” (hydrogen injection port adaptor) refers to a device that may be used as a substitute and/or replacement for a spark plug in an internal combustion engine, comprising a hydrogen channel and a spark producer. In particular embodiments of the invention, a HIPA may also comprise screw threads on one end that are designed to screw into standard spark plug apertures on an engine, a hydrogen input tap, baffles within the hydrogen channel, a spark Venturi, positive and negative electrodes, a hydrogen chamber sensor and/or a spark area sensor.

Terms that are not otherwise defined herein are used in accordance with their plain and ordinary meaning. In the following detailed description, numerous specific details are set forth in order to provide a thorough understanding of the present invention. However, it will be apparent to one of ordinary skill in the art that these specific details need not be used to practice the present invention. In other circumstances, well-known structures, compounds, circuits, processes and interfaces have not been shown or described in detail in order not to unnecessarily obscure the present invention.

Apparatus and/or Kit for Conversion of ICE Vehicles

The following discussion is directed to embodiments for converting standard automobile engines to run on hydrogen gas. However, the methods, apparatus and kits are also of use for conversion of alternative engine designs, such as a Wankel engine or any other ICE engine known in the art.

Hydrogen Injection Port Adaptors (HIPAs)

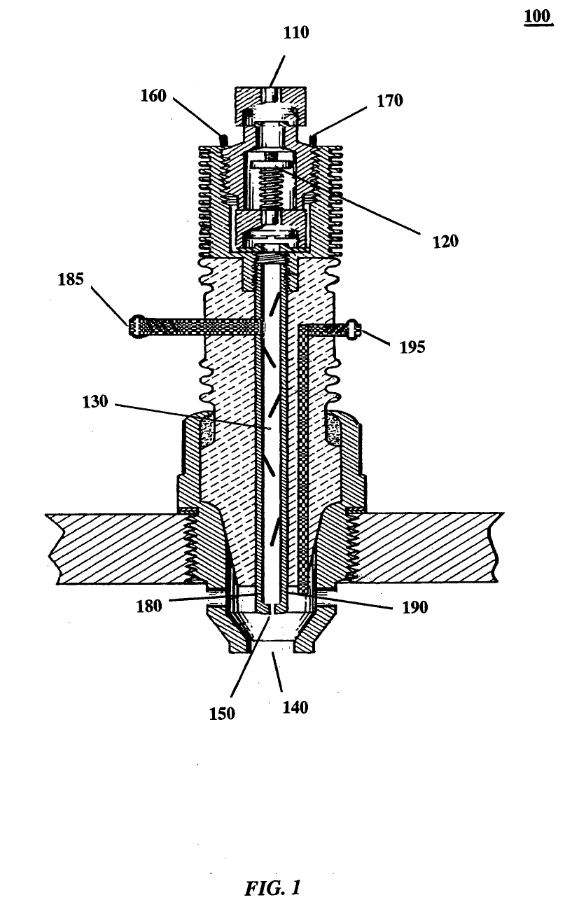

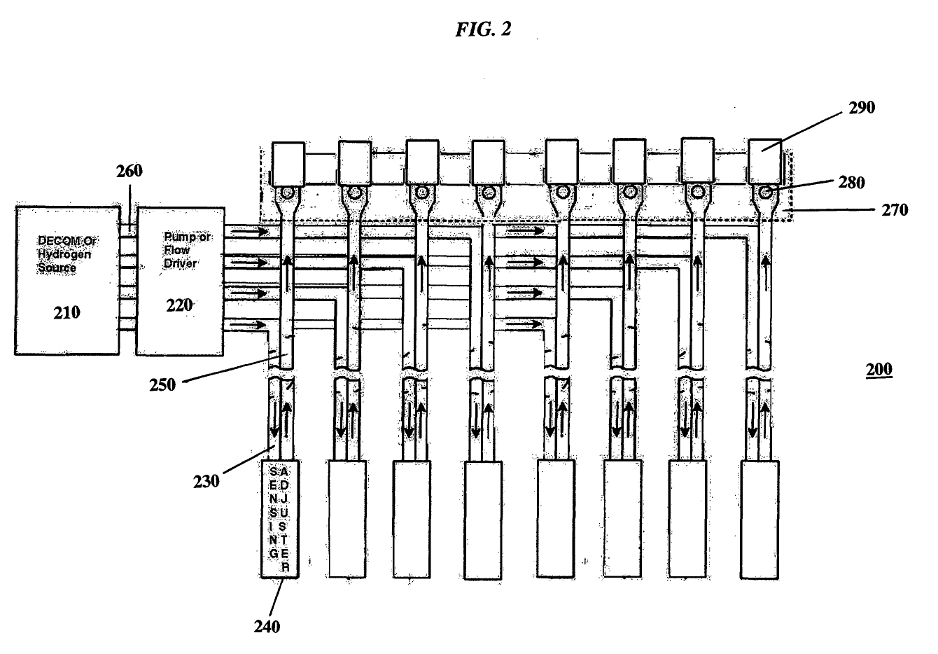

The existing spark plugs may be removed from the engine and replaced with a set of HIPAs 100 (FIG. 1). The HIPAs 100 may have screw threads on one end that are designed to screw into standard spark plug apertures on an engine. A hydrogen input tap 110 may be connected via a gas manifold (FIG. 2, 200) to any source of hydrogen gas fuel. Hydrogen fuel may pass from the input tap 110 through a manual hydrogen flow adjustment valve 120 to a hydrogen channel 130. In alternative embodiments of the invention, a hydrogen flow adjustment valve may be automatically adjustable or may be controlled by an external controller, such as a CPU. As illustrated in FIG. 1, in certain embodiments of the invention the hydrogen channel 130 may comprise baffles to help prevent backflow of exhaust gases into the manifold (FIG. 2, 200) upon ignition of the hydrogen. Hydrogen gas may pass out of the hydrogen channel 130 through a spark Venturi 140 and is injected into the engine chamber, where it mixes with air that has entered the chamber from a carburetor or fuel injector or equivalent system. The HIPA 100 and/or the ignition chamber may be designed to optimize mixing of hydrogen gas and air within the chamber. Various designs for optimizing gas mixing within an engine chamber are known in the art and any such known design may be used. Although the illustrative embodiment shown in FIG. 1 comprises a central hydrogen channel 130 in the HIPA, in alternative embodiments it is envisioned that the hydrogen channel 130 may be offset from the center of the HIPA 100.

The HIPA 100 contains a central spark producer with a spark gap 150 between positive 180 and negative 190 electrodes. The electrodes 180, 190 are connected to the automobile ignition system through positive 160 and negative 170 terminals. The skilled artisan will realize that the disclosed terminals are exemplary only and that the electrodes 180, 190 may also be connected to the electrical (ignition) system of the vehicle using alternative arrangements, such as the standard negative ground system used in various automobiles. Application of an electrical potential results in the generation of a spark across the spark gap 150 that ignites a hydrogen-air mixture in the engine chamber. To produce a spark, each HIPA 100 is connected to an electrical source, such as a distributor and coil or a solid-state ignition system. Electrical leads to the terminals 180, 190 may be incorporated into a single connector containing a gas line from the manifold 200, or alternatively the electrical leads may be connected separately from the gas line.

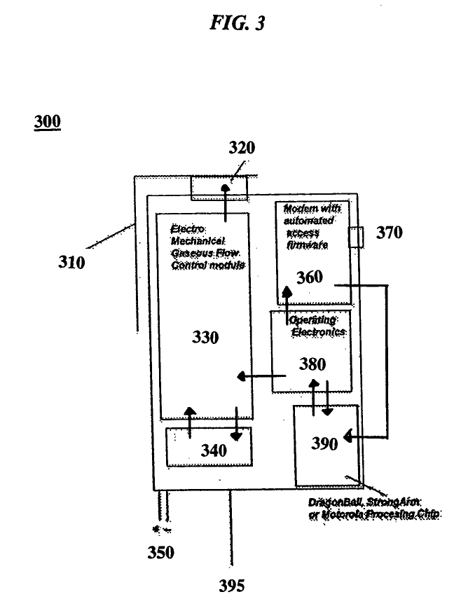

In various embodiments of the invention, the HIPA 100 also comprises a connector for a hydrogen chamber sensor 185 and/or for a spark area sensor 195. The sensors may connect to an on-board information processing and control system, such as a mini-computer (CPU, FIG. 3, 300) to provide real-time data on engine conditions, The sensors may report a variety of operating conditions to a computer (FIG. 3, 300), such as the temperature and gas pressure inside the cylinder, whether or not the gas in the chamber has ignited (i.e., the cylinder has fired), the timing of hydrogen ignition, and whether or not a backfire has occurred. The CPU (FIG. 3, 300) may provide automatic adjustment of hydrogen pressure, flow rate, air-fuel ratio, ignition timing and other parameters to optimize engine performance. In certain embodiments, the sensors may comprise part of a feedback loop system with the CPU to optimize engine performance. In various embodiments, the CPU may incorporate learning functions, such as a neuro, fuzzy, or neuro-fuzzy controller to allow the system to “learn” how to optimize the performance of a particular vehicle by varying parameters, such as hydrogen flow rate, hydrogen-air mixture, ignition timing, etc. and monitoring engine and/or vehicle performance.

Gas Manifold

The apparatus and/or kit may also comprise a gas manifold 200, as illustrated in FIG. 2. The manifold 200 connects a hydrogen fuel source 210, such as a Decom™ unit 210, to each of the HIPAs (FIG. 1, 100). Hydrogen gas from the fuel source 210 may be provided to a pump or flow driver 220 through one or more gas cables 260. In certain embodiments of the invention, the manifold may incorporate a staggered pump 220 that can control the amount of hydrogen provided to each engine cylinder. Hydrogen gas may pass from the pump or flow driver 220 through a first tube 230 to a sensing adjuster 240. The adjuster 240 allows additional control of the pressure and flow rate of hydrogen gas passing to each HIPA (FIG. 1, 100). The hydrogen gas passes out of the sensing adjuster 240 through a second tube 250 and is provided to a manifold block processing hub 270. A gas flow and temperature sensor 280 may be inserted into each second tube 250 to provide feedback to the CPU (FIG. 3, 300). An adjustment solenoid 290 may be located at the end of each second tube 250 to control movement of gas from the manifold 200 to the HIPAs (FIG. 1, 100).

Each HIPA (FIG. 1, 100) may be connected to the manifold 200 by flexible tubing. Alternatively, HIPAs (FIG. 1, 100) may be connected to the manifold 200 by any known type of rigid tubing. In certain embodiments, the manifold 200 may act to regulate the hydrogen gas pressure provided to each cylinder. For example, where the hydrogen source 210 is a high pressure compressed hydrogen tank, hydrogen may be supplied to the manifold 200 at a pressure of between 5,000 to 10,000 psi, while hydrogen will preferably be supplied to the engine at much lower pressures. Thus, the manifold 200 may function as a pressure regulator. Alternatively, an accessory pressure regulator may be interposed between the hydrogen source 210 and the manifold 200. In preferred embodiments, a gas trap is located at the connection between the HIPA (FIG. 1, 100) and the manifold 200. The gas trap prevents any potential backflow of gas from the cylinders to the gas manifold 200.

The gas manifold 200 and the HIPA sensors may be operably coupled to an information processing and control system, which may be a computer or central processing unit (CPU, FIG. 3, 300). The CPU (FIG. 3, 300) obtains and processes information on the operating conditions of the vehicle, such as the engine temperature, load on the engine, torque, operating transmission gear, rpm, gas pressure in the cylinders, ignition timing, presence or absence of backfires, and operator controlled functions (e.g. extent to which the accelerator or brake is depressed). The CPU (FIG. 3, 300) then controls the gas flow from the hydrogen fuel source to the manifold, the amount of hydrogen gas and air provided to each cylinder, and the timing of ignition of each cylinder.

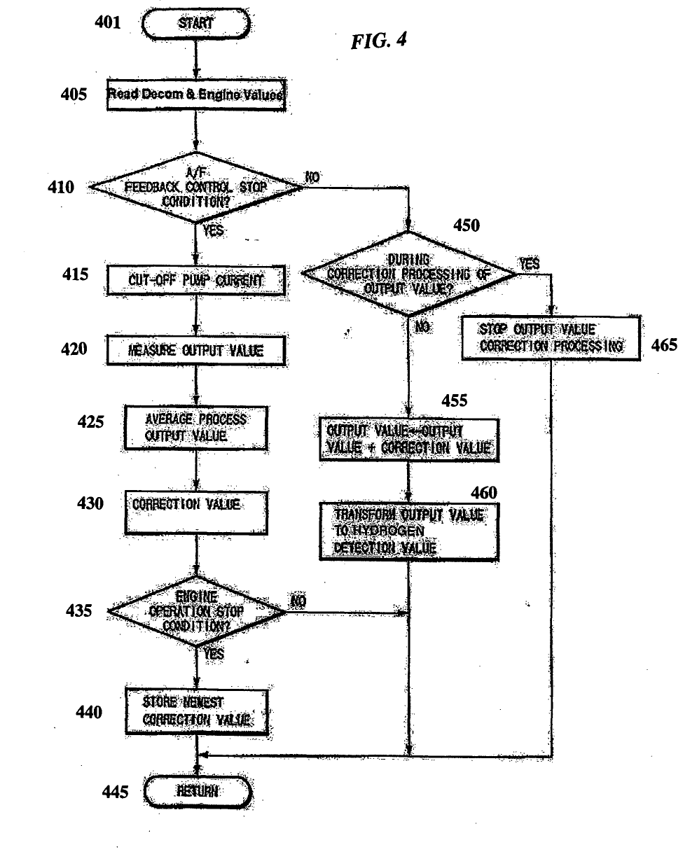

The gas manifold 200 may receive hydrogen gas from the fuel source 210 and sequentially send hydrogen to each HIPA (FIG. 1, 100). The manifold 200 may time the interval and/or pressure of gas flow to control the amount of gas provided to each cylinder. The manifold 200 may measure the back pressure from each HIPA (FIG. 1, 100) and report information to the CPU (FIG. 3, 300). Upon detecting a potentially dangerous hydrogen leak in the system or other dangerous vehicle condition, the manifold 200 may act to stop all hydrogen gas transfer (e.g., FIG. 4). The hydrogen source 210 may optionally be fitted with a separate hydrogen cut-off switch, to be operated by the CPU (FIG. 3, 300) and/or gas manifold 200.

In preferred embodiments, the manifold 200 monitors and/or regulates gas flow and gas pressure to each HIPA (FIG. 1, 100), while allowing a continuous flow of gas as required for engine operation. In embodiments where temperature control of the HIPA (FIG. 1, 100) and/or engine chambers is provided, the manifold 200 may control flow of coolant and/or electrical fan operation. In certain embodiments, the manifold 200 may act to degas one or more engine chambers if a backfire potential is detected. Various embodiments of the manifold 200 may comprise a housing, two-position electronic valves, a two-position master electronic valve, pressure sensors, couplers, a DC voltage source, electronic signal and out connects, thermal sensors, back flow valves, and other components known in the art. Exemplary embodiments of components that may be incorporated into a gas manifold 200 include a Quantum Technologies (Irvine, Calif.) injector pressure regulator (IPR), a Quantum Technologies controller, and/or one or more Quantum Technologies sensors and/or actuators. CPU

An exemplary embodiment of a CPU 300 is disclosed in FIG. 3. The CPU 300 may comprise and/or be operably coupled to a thermally insulated housing 310, a HIPA sensor multi-tap 320, an electromechanical gas flow control module 330, a hydrogen pressure and purity sensor 340, a power source 350 such as the vehicle direct current system 350, a modem 360 with automated access firmware, an RJ phone connector 370 (e.g., US RJ-11 connector), operating electronics 380 and/or a DragonBall, StrongArm, Motorola or any other processing chip 390 known in the art. A validating signal input 395 from the timing disk may also be operably connected to the CPU 300. Exemplary pathways for information flow and/or electrical signals between the various components of the CPU is illustrated in FIG. 3 by directional arrows.

The skilled artisan will realize that alternative configurations of a CPU 300 that may contain different components may be of use in the disclosed apparatus, kits and methods and that any type of CPU 300 known in the art may be used within the scope of the claimed invention. In particular embodiments, the CPU 300 may be installed in the engine or passenger compartment of a vehicle to be converted. An existing CPU 300 may be reprogrammed or may have an alternative EPROM installed. The EPROM may contain one or more alternative programs for operating the hydrogen-fueled vehicle. Any type of CPU known in the art may be used.

In certain embodiments, a CPU 300 or other computer 300 may be programmed remotely by attaching the computer 300 to a phone line or other connection to a remote computer system. Such remote programming may be used to provide accurate timing and engine setting information, specific for the make, model and/or year of the vehicle to be converted. The provision of accurate timing and engine setting information serves to reduce backfires and pre-ignitions from inaccurate timings and other causes, providing a significant advantage over any current methods of ICE vehicle conversion. Alternatively, the CPU 300 and/or EPROM may be preprogrammed to operate selected vehicles on hydrogen fuel. The proper operating program may be selected by entering an identifier for the vehicle that is being converted to run on hydrogen fuel.

In some embodiments, control of the system may be implemented using a master and slave design. In such a design, the CPU may interact with a number of different subsystems using only data that is relevant to each subsystem. The subsystems may include, but are not limited to, a communication subsystem, a motor control subsystem, a Decom™ control subsystem and one or more additional subsystems. With a master and slave design, the individual subsystems function independently and may perform their duties using a variety of control variables that are not directly linked to the CPU. An example of one embodiment of an individual subsystem, in the form of a Decom™ control subsystem, is discussed below.

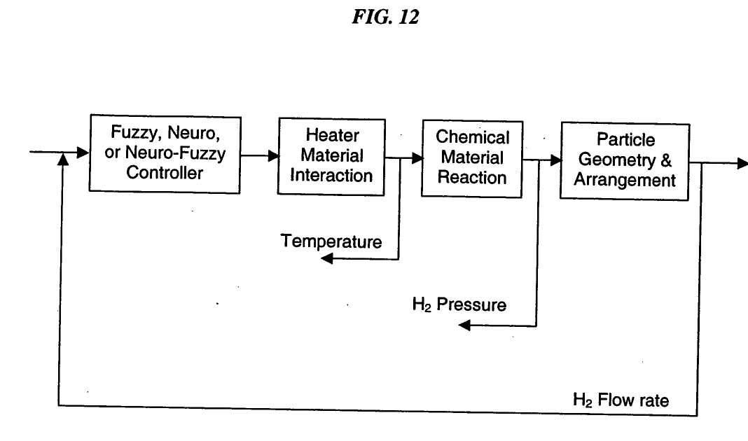

In certain embodiments of the invention, hydrogen fuel may be supplied by a Decom™ unit as discussed below. The Decom™ unit may contain a variety of hydrogen storage materials, such as a doped sodium alanate composition. Hydrogen gas may be desorbed from the hydrogen storage material by thermal activation, as by the activity of an electrical resistance heater, catalytic heater or other heaters known in the art. The function of the Decom™ unit may be regulated to provide specified flow rates of hydrogen to the Motor Control subsystem. Where an electrical heater is used, the degree of heating, temperature of the hydrogen storage material and consequent rate of hydrogen release may be controlled by controlling the applied voltage. The hydrogen flow rate depends on parameters such as the heat transfer from the heating device to the hydride storage material, chemical reactions during desorption, and the geometrical arrangement of the metal powder particles inside the fuel cassette (FIG. 12). For those of skill in the art, it will be apparent that a standard control approach using models and constitutive equations, that are difficult to obtain, could provide less than optimal performance and that an intelligent controller is more likely result in optimized engine performance. Certain embodiments of the subsystem therefore incorporate a neuro, fuzzy, or neuro-fuzzy controller as depicted in FIG. 12. The subsystem may provide a learning approach to parameters controlling hydrogen release and gas flow rate, allowing for improved subsystem control without the need to generate more accurate models. The benefit of this approach is that there is no need for a precise model of the plant. In the case of a neural network controller, the neural net can be trained using the various readings from temperature, pressure, flow rate and other sensors.

FIG. 4 illustrates an exemplary method of operating a hydrogen powered ICE vehicle using a CPU (FIG. 3, 300). The CPU may be programmed in a variety of ways to optimize engine performance, maximize fuel economy, detect hazardous vehicle conditions or to otherwise control system function. The system is initialized, at block 401, typically by turning on the ignition key. The CPU module receives power and begins its activation and validation cycle. At block 405 the conditions of the Decom™ (hydrogen fuel storage) unit and engine may be determined by reading Decom™ and engine values. The skilled artisan will realize that a variety of parameters may be determined, including but not limited to the amount of hydrogen fuel remaining in storage, the temperature and gas pressure of hydrogen storage modules such as FuelCassettes™, sensor data from the HIPAs, battery voltage, and engine parameters. The current state readouts from the engine sensors at the timing system and spark plug sensors are read, along with the status and confirmation of operation of the Decom™ unit. System input may also include operator determined parameters, such as the degree of depression of the accelerator and/or brake pedal.

At block 410, a determination is made whether an A/F feedback control stop condition exists. A comparison of all of the external data with approval tables in firmware is undertaken. If all systems pass a good-to-go test the operation begins (YES). If not (NO), then a validation and checking process cycle is undertaken 450. The conditions generating an A/F feedback control stop condition and the timing of a control stop may be provided by a predetermined setting or specification that may be downloaded or otherwise programmed into the CPU.

At box 415, a safety decision is made and constantly rechecked regarding the amount of hydrogen to allow through the system so that system operation is truly on-demand and so there is never more gaseous hydrogen on-board than the system needs at any given point. Where appropriate, a hydrogen pump cut-off may be triggered to initiate a transient or long-term shut-off of hydrogen flow to the engine. If a feedback control stop condition is detected, this may cause the CPU to cut off pump current 415. Pump current cut-off 415 may stop, or at least slow, the flow of hydrogen from the Decom™ or other hydrogen storage unit to the gas manifold. The skilled artisan will realize that a sudden loss of power may itself constitute a hazardous condition under some circumstances. For example, a vehicle operating at freeway speeds, subject to sudden power cut-off, may become involved in an accident. In certain embodiments, the system parameters to be checked may include the operating conditions (such as speed) of the vehicle. Depending on the severity of the hazardous condition detected and the operating conditions, the CPU may initially trigger a warning to the operator, such as an alarm, flashing light indicator and/or prerecorded audio warning, to provide a short time period for the operator to safely bring the vehicle to a halt prior to hydrogen gas cut-off.

At box 420, the output value of the engine sensors is measured. The measured output value may be average processed with other output values, at block 425. One or more correction values to be applied to the Decom™ unit and/or engine may be determined based on the average processed output value, at block 430. The correction value may represent a correction that helps to prevent backfiring, for example. The adjustment data is sent to the Decom™ and/or engine devices. The correction process allows for the fact that different vehicles of the same make, model and year may operate differently, depending upon such factors as maintenance history, mileage, environmental conditions and operator use. Although operating and control parameters, such as ignition timing, may be selected for a general type of vehicle, the ability of the CPU to update such parameters for the individual vehicle will provide further optimization of engine and vehicle performance specific for the individual vehicle.

At block 435 an analysis is performed regarding hydrogen flow and timing of ignition in the engine and fire safety sensor and a determination is made whether to continue the good-to-go cycle (YES) or go to critical system mode (NO). The system monitors whether or not the engine is operating better with the correction values than the downloaded tables and stores updated material for the user to approve, based on a comparison to settings to see if the downloaded timing and setting metrics are working better or if what the CPU has learned will make the engine run better. Improved engine function results in a storage of new correction values at block 440. At block 445 the good-to-go cycle restarts back to block 401 and cycles again. Using the cyclic learning process, the CPU may continually update control parameters to maximize the efficiency of engine performance.

A validation and checking process is triggered at block 450 in response to a “NO” determination at block 410. The validation checking of all values is rapidly performed and if the result is positive (YES) the system returns to the good-to-go cycle. The critical checking is validated at block 465 prior to return to normal cycle operations.

Alternatively, if “NO” is the determination at block 450, the validation and checking process continues to block 455, where all of the engine and sensor output values are compared to the proper values to determine if the output values exceed any metrics on firmware stored tables. If so, the car emergency light is triggered to start blinking and engine hydrogen flow is shut off. In addition to engine shut-off, if the output level is high enough compared to stored tables, or of an urgent enough nature, then all of the data is stored in an error log and hydrogen release, warning and venting systems are deployed at block 460. As discussed above, depending upon the severity of the hazardous condition and the operating status of the vehicle, the programming allows for the possibility of either an immediate, delayed or gradual shut-off of vehicle power.

In one aspect, the correction processing of output values may be performed according to a fixed schedule, such as once every 1-100 or every 10 miles of driving. Generally to achieve good results, the correction processing should be performed as soon as the processing at the blocks on the left-hand side of the diagram have obtained enough update data to allow the output value to be corrected.

Timing Device

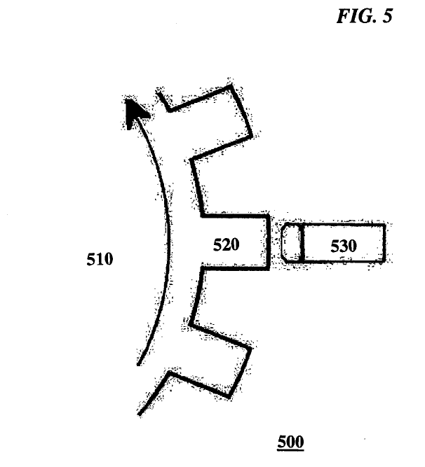

Certain embodiments of the invention may comprise a timing disk and sensor 500, as illustrated in FIG. 5. The timing disk and sensor 500 may be integral to the engine, or may alternatively be attached to an existing engine. For example, the timing disk and sensor 500 could be mounted to a wheel or pulley attached to the front end of the crankshaft. In an exemplary embodiment, the timing disk 510 may comprise a toothed disk 510, with the individual teeth 520 corresponding to the cylinders of the engine. As the disk 510 rotates, the teeth 520 pass in front of a timing sensor 530. The sensor 530 detects the motion of the teeth 520 and triggers the CPU (FIG. 3, 300) to ignite the appropriate engine cylinder.

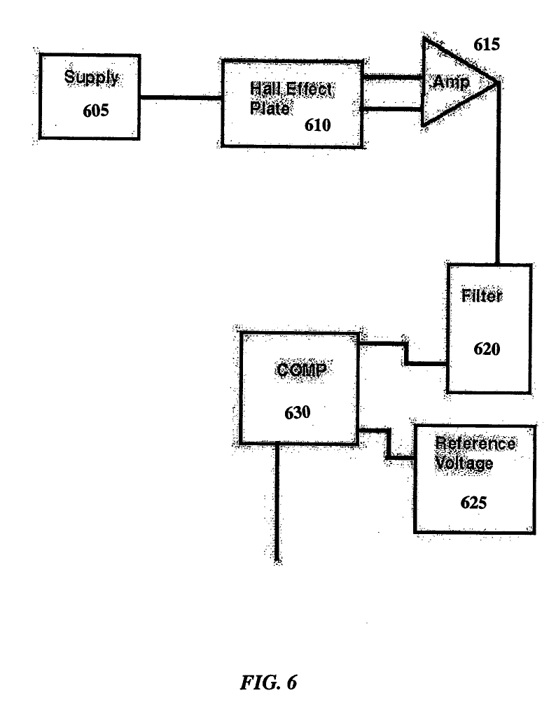

FIG. 6 shows a block diagram of an exemplary apparatus for controlling engine ignition using a timing disk 510 and a timing sensor 530 such as those shown in FIG. 5. A power supply 605, such as the car battery and/or electrical system, may provide power to a Hall effect plate 610 of the timing sensor. The Hall effect plate may be positioned relative to the timing wheel so as to be electromagnetically affected by a tooth of the timing wheel as it rotates with the wheel. The electromagnetic affects of the tooth on the Hall effect plate may be related to the rotational position of the tooth, which in turn indicates the relative positions of the various engine cylinders. Generally the electromagnetic effect may increase with increasing proximity of the tooth to the Hall effect plate. The Hall effect plate may output a signal that is indicative of the position of the tooth. The signal may be provided to an amplifier 615 that may amplify the signal. Amplification is not required but may be appropriate depending on the characteristics of the original signal. The amplified signal from the amplifier may optionally be provided to a filter 620 to isolate a portion of the amplified signal that is characteristic of the position of the tooth. The filtering may help to remove noise or other portions of the amplified signal that are due to other electromechanical systems, such as spark plug firing, radio function, distributor function, etc. After any optional filtering the filtered signal may be provided to a comparator 625 along with a reference voltage from a reference voltage source 630.

An exemplary rotational position may include a position in which the tooth is most closely proximate the sensor, as shown in FIG. 5, although this is not required. The comparator may compare the filtered signal with the reference voltage and output a signal based on the comparison. The output signal from the comparator may indicate that the tooth is in the position associated with the reference voltage, or not. The output signal may be provided, for example, to a CPU to initiate firing of an engine cylinder. The apparatus shown in FIG. 6 may assist with determining a rotational position of the timing wheel, and may assist with timing spark ignition for each cylinder. As discussed above, the CPU may operate in a learning mode that is capable of advancing or delaying the ignition timing, relative to the timing wheel tooth position, to optimize engine and vehicle performance.

Kits

Various components that may be included in a kit for conversion of ICE vehicles may comprise, but are not limited to, a set of HIPAs, a gas manifold, flexible gas tubing to connect the HIPAs to the manifold, a power cable, a timing disk, a timing disk sensor, a timing disk cable, a central processing unit (CPU), a gas cable to connect the manifold to a hydrogen fuel source, a sensor cable, a backfire baffle and a shunt. The skilled artisan will realize that a kit may comprise any component, item or tool that is of use for converting an ICE engine to run on hydrogen fuel. Thus, the kit components are not limited to those disclosed in the exemplary embodiment, but may include other items known in the art, such as a socket wrench, plastic or metal retaining clips, screws, bolts, valves, tape, sealant and/or any other component that may be of use in the conversion. In preferred embodiments, users of such kits may convert an ICE vehicle to hydrogen fuel for a few hundred dollars, providing significant cost savings compared to any alternative hydrogen conversion kits. Optionally, a conversion kit may also comprise a hydrogen fuel source, or such fuel source may be separately installed.

Hydrogen Fuel Source

In various embodiments of the invention, hydrogen fuel to power the converted ICE vehicle may be provided by any hydrogen fuel source known in the art, including without limitation compressed or liquified hydrogen storage tanks, metal hydride tanks, solid borohydrides or aqueous borohydride solutions, hydride slurries, doped sodium alanate or other alanate compositions, carbon nanotubes, nanoparticles, microspheres and/or a hydrocarbon reformer. Sources of hydrogen gas and methods of producing hydrogen from those sources are well known in the art. Additional information on hydrogen fuel sources, apparatus and methods of use are disclosed in U.S. patent application Ser. Nos. 10/099,274 and 10/099,771, filed Mar. 15, 2002, 10/241,125, filed Sep. 9, 2002, 10/463,352, filed Jun. 16, 2003, 10/263,618, filed Oct. 2, 2002, and 10/310,498, filed Dec. 2, 2002, the entire contents of each of which are incorporated herein by reference.

Hydrogen Storage Tanks

Hydrogen storage tanks that could be installed in existing ICE vehicles are under development. Liquid hydrogen storage tanks may be double-walled stainless steel cylinders with multiple insulating layers (e.g., Linde Gas Inc., Wilmington, Del.). A problem with liquid hydrogen storage is to maintain the tank contents at very low temperatures that prevent boil off of gaseous hydrogen. Another concern is to maximize hydrogen storage without requiring an excessive amount of space. Flat-profile, elliptical cryogenic hydrogen tanks that are designed to optimize the amount of hydrogen storage per unit space may be of use in ICE vehicle conversion.

Another form of hydrogen storage uses compressed hydrogen gas tanks. Refrigeration is not an issue with compressed hydrogen. However, such systems tend to operate at very high pressures of 5,000 to 10,000 psi. Exemplary hydrogen storage tanks may be obtained from commercial sources, such as the Quantum Technologies TriShield™ tank (Irvine, Calif.). Where high-pressure tanks are used, a Quantum Technologies NGR 3600 in-tank high pressure regulator may also be of use.

Metal Hydrides

Metal hydride based hydrogen fuel sources are well known in the art (e.g., U.S. Pat. Nos. 4,211,537; 4,728,580; 4,667,185; 6,165,643). Hydrogen gas under high pressure can permeate a variety of metals to form metal hydrides. Hydrogen is released upon heating of the metal hydride. Hydrogen generation using metal hydride or metal alloy hydrides is well known (U.S. Pat. Nos. 4,302,217; 4,537,761; 4,570,446; 4,599,867; 5,360,461; 5,797,269; 5,962,155; 5,987,895; 6,143,052; 6,194,092; 6,267,229).

Hydrogen Reformers

Hydrogen fuel sources based on reformation of hydrocarbons are also well known (e.g., U.S. Pat. Nos. 5,601,937; 5,928,805; 6,267,792; 6,318,306). Hydrogen may be produced by reformation of hydrocarbons, such as natural gas or methane. Alternative embodiments may utilize steam reformation of hydrocarbons with water vapor or partial oxidation (POX) reformation with a burner or catalyst. Certain hydrocarbon reformers are designed to operate at very high temperatures, for example, between about 600 to 800° C. (U.S. Pat. No. 5,601,937). Such elevated temperatures may not be conducive to use in automobiles and lower temperature systems are preferred.

Borohydride Based Hydrogen Sources

Borohydride based hydrogen fuel sources, are known in the art (see, e.g., U.S. Pat. Nos. 4,000,003; 4,002,726; 4,628,010; 5,372,617). In the presence of an appropriate catalyst, such as platinum, aqueous borohydride solutions react with water to generate hydrogen and borate. An alternative embodiment of a borohydride based system is disclosed in U.S. Pat. No. 4,628,010, which shows hydrogen generation by reaction of lithium borohydride with iron oxide. Solid chemical hydrides, such as lithium borohydride, sodium borohydride, calcium hydride, lithium aluminum hydride or lithium hydride may generate hydrogen upon exposure to water (U.S. Pat. Nos. 4,000,003; 5,372,617; 5,702,491).

Carbon Nanotubes

Although still in the development stage, carbon nanotube based hydrogen storage systems may be of use as a hydrogen fuel source (e.g., Dillon et al., “Carbon Nanotube Materials for Hydrogen Storage,” Proceedings of the 2001 DOE Hydrogen Program Review). Single-walled carbon nanotubes can reportedly store up to 7 weight percent of hydrogen gas. Methods for preparing carbon nanotubes are known (e.g., U.S. Pat. Nos. 6,258,401; 6,283,812; 6,297,592). Carbon nanotubes may also be obtained from commercial sources, such as CarboLex (Lexington, Ky.), NanoLab (Watertown, Mass.), Materials and Electrochemical Research (Tucson, Ariz.) or Carbon Nano Technologies Inc. (Houston, Tex.). Methods of adsorption and desorption of hydrogen from carbon nanotubes are disclosed in Dillon et al. (2001).

Doped Sodium Alanate Hydrogen Fuel Source

In an exemplary preferred embodiment, the hydrogen fuel source comprises a doped sodium alanate composition. The reaction pathway for absorption and release of hydrogen for doped sodium alanate is as shown below.

3 NaAlH₄♯Na₃AlH₆+2 Al+3 H₂ (Eq. 1)

Na₃AlH₆♯3 NaH+Al+3/2 H₂ (Eq. 2)

The dehydrogenation of NaAlH₄ is thermodynamically favorable, with 1 atmosphere (atm) of desorption pressure reported at 33° C. using NaAlH₄ doped with 2 mol % each of the transition metal alkoxides Ti(OBuⁿ)₄ and Zr(OPr)₄. (Gross et al., in Proceedings U.S. DOE Hydrogen Program Review, NREL/CP-570-28890, 2000.) However, the dehydrogenation of Na₃AlH₆ is less favorable, with 1 atm of desorption pressure estimated to occur at about 110° C. (Gross et al., 2000).

The sodium alanate may be doped with a catalyst, such as {n⁵-C₅H₅}₂TiH₂. The use of unsaturated, 5-carbon cyclic ring structures to coordinate the titanium catalyst is advantageous in that it stabilizes the catalyst in the +3 redox state. Ti³⁺ is preferred to Ti⁴⁺ as a catalyst for sodium alanate hydrogen storage. The use of cyclopentadienyl ring compounds to coordinate with the titanium catalyst provides the additional advantage of increasing the maximum wt. % of recyclable hydrogen storage compared with other known dopants. The cyclopentadienyl rings may be removed from the doped sodium alanate by several cycles of hydrogen discharge and recharge (i.e. heating to 100° C.). Compared to non-volatile titanium compounds, such as titanium chlorides, the use of volatile hydrocarbon rings provides substantial weight advantages. It is also advantageous that the compound does not contain any oxygen like the alkoxide-coordinated transition metal catalysts, as oxygen has been reported to interfere with cyclic discharge and recharge of alanates (Gross et al., 2000).

The dopant may comprise unmodified cylcopentadienyl rings. Alternatively, virtually any modification and/or substitution could be made in the cyclopentadienyl ring structure, so long as it is still capable of coordinating with and stabilizing Ti³⁺. Such substitutions and/or modifications of cyclopentadienyl rings are known in the art (see, e.g., U.S. Pat. Nos. 5,504,223; 5,703,257; 6,197,990). Preferably, such substitutions and/or modifications would not interfere with the removal of the hydrocarbon compound by heating and/or by cyclic hydrogen discharge and recharge.

The molar ratios of NaH, aluminum and dopant may be adjusted to provide optimal percent weight hydrogen storage. In a non-limiting example, the ratios of NaH:aluminum:titanium are 0.7:1.0:0.1. However, molar ratios of NaH may vary between 0.1 to 0.88, while molar ratios of dopant may vary from 0.04 to 0.3. Molar ratios of aluminum of about 1.0 are preferred. Typically, for each mole of dopant added to the composition, 3 moles of sodium would be removed, since each titanium can coordinate up to three hydrogens. The use of such molar ratios is advantageous in providing the maximum weight percent of hydrogen storage and in optimizing the thermodynamic properties of hydrogen discharge and/or recharge. Another advantage is in increasing the amount of hydrogen available to be released at 100° C.

Titanium may be replaced with zinc, Sc, Y, La, Hf, V, Nb, Ta and/or any of the known lanthanides or actinides. Preferably, the transition metal would be coordinated with the same type of cyclopentadienyl ring structure to form the initial doped sodium alanate composition.

Any known method of preparing doped sodium alanate may be used. These include, but are not limited to, mixing the components in organic solvent followed by vacuum removal of solvent (U.S. Pat. No. 6,106,801), magnetic or other stirring of powdered components (U.S. Pat. No. 6,106,801), and/or ball milling of dry sodium alanate with dry or liquid dopant under argon or another noble gas (e.g., Jensen et al., Int. J. Hydrogen Energy, 24:461, 1999; Zidan et al., J. Alloys and Compounds, 285:119, 1999; Gross et al., in Proceedings U.S. DOE Hydrogen Program Review, NREL/CP-570-30535, 2001).

Alternatively, doped sodium alanate may be prepared by brief mixing and melting of the components. For example, NaH, Al and {n⁵-C₅H₅}₂TiH₂ may be mixed together by any known method and the mixture heated to 182° C. or higher. The time of heating is not considered critical, so long as it is sufficient to melt the doped sodium alanate composition. Heating may be maintained for a time sufficient to drive off the cyclopentadienyl ring component of the mixture. A non-limiting example would be to heat the mixture to between 200 to 250° C. for 5 to 30 minutes.

Cassette Storage System for Hydrogen Fuel

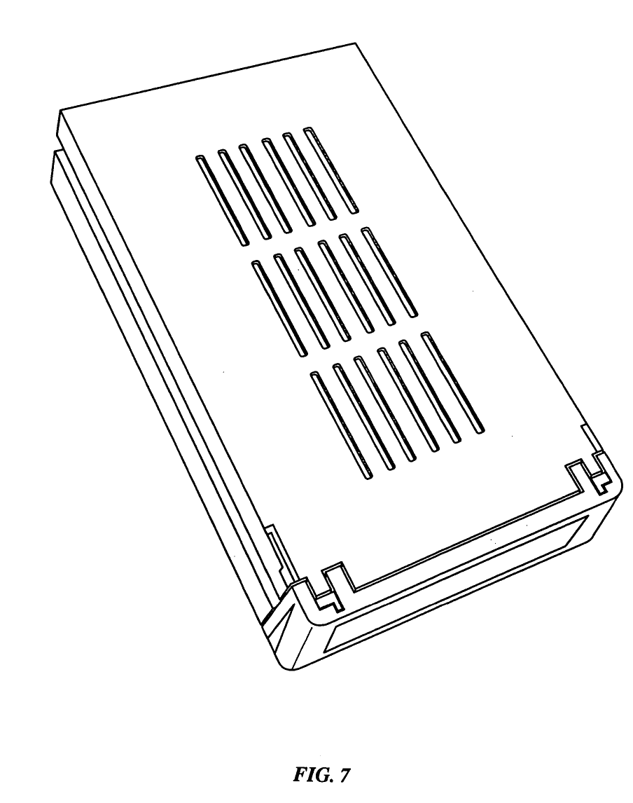

In certain embodiments of the invention, doped sodium alanate compositions or other hydrogen storing materials may be stored, transported and/or used in interchangeable cassette modules. An exemplary embodiment of a cassette is shown in FIG. 7. Cassettes may be charged with hydrogen gas under high pressure while attached to a converted ICE vehicle. In this case it may be preferred to include a cooling system to remove excess heat that is generated during the hydrogen charging process. Alternatively, after being depleted of hydrogen the cassettes may be removed from the vehicle and replaced with charged cassettes, while the depleted cassettes may be recharged in a separate hydrogen charging system. In such embodiments, hydrogen charging may occur at relatively slow rates and low temperatures, eliminating the need for a separate cooling system for charging the cassettes. Where rapid rates of hydrogen charging are preferred, a cooling system comprising any form of heat transfer device known in the art may be used. Non-limiting examples include fluid or water-filled tubes, water jackets, cooling fins and other radiative devices, heat pumps, fans, etc.

Advantages of the cassette system include its safety, ease of use, low cost and transportability. The cassettes are waterproof and gas leak proof. They are resistant to thermal, electrical and mechanical stress, as might occur in a vehicle collision. During storage and transport, the doped sodium alanate or other hydrogen-storing compositions should release only low amounts of hydrogen gas. Thus, the cassettes may be transported with little or no internal gas pressure. Because of the flammable and potentially explosive nature of hydrogen gas, the ability to transport the cassette with little or no internal pressure is a significant safety advantage.

A non-limiting example of a cassette is an A2 Hfuel™ cassette (FIG. 7) (FuelSell Technologies, Inc., San Francisco, Calif.). Each A2 size cassette holds up to a liter of a hydrogen storage composition. In preferred embodiments, the cassette is configured to fit into a cassette-receiving receptacle of a Decom™ unit (FuelSell Technologies, San Francisco, Calif.). The cassette may comprise a rigid, impact resistant plastic casing that may have a pivoted handle at one end. Any type of strong, impact, thermal and chemical resistant plastic may be used, such as polycarbonate, PVP, PTFE, vinyl or acrylic. Other casing materials of use include aluminum, a ceramic and/or a composite of aluminum, ceramic and/or plastic. In some embodiments, the cassette may comprise a spring-loaded or other type of door that is pushed open when the cassette is inserted into the receptacle, allowing an inlet/outlet coupling to connect to a hydrogen valve on the cassette. In other embodiments, a metalized paper or plastic covering may be sealed over an aperture in the cassette with adhesive. The user would peel off the sealant before inserting the cassette into the receptacle. Flanges on the cassette housing may be used to align the cassette with the receptacle and inlet/outlet coupling. In various embodiments, it is contemplated that any hydrogen valves would be located on the side of the cassette that is pushed into the receptacle and mating with the coupling would occur automatically when the cassette is firmly seated in the receptacle. In alternative embodiments of the invention, the hydrogen valve(s) may be located on the side of the cassette facing away from the receptacle and the user may manually attach one or more couplings to the valve(s).

In addition to a thermoplastic outer cover, the doped sodium alanate or other hydrogen storage material may be further enclosed in one or more layers of other material to provide additional protection against puncture and exposure to the environment. Exposure of sodium alanate, borohydride or other compositions to water, for example, could result in rapid release of hydrogen that may form an explosive mixture with air. Materials that may be used as additional sealing layers include, but are not limited to, a flexible metalized fabric, Mylar, plastic/foil, Kevlar™, SpectraFabric™ antiballistic woven mesh fabric or similar robust yet lightweight thin skin or sheath housing. The use of flexible materials for the additional layers is preferred, as impact with a pointed object would be less likely to puncture a material that can deform.

Hydrogen Valve

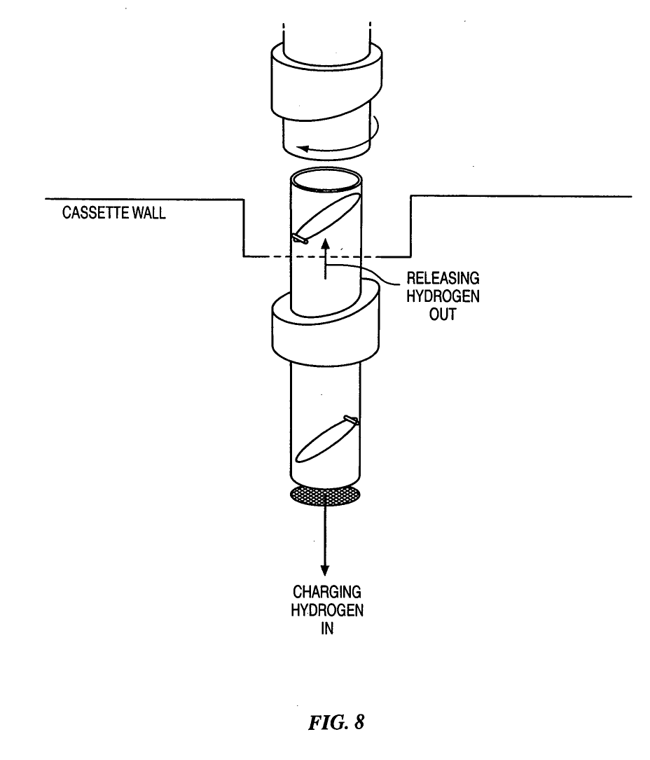

In certain embodiments of the invention, the cassette may comprise one or more hydrogen valves (FIG. 8). The valve would normally be in a closed position, preventing entrance or exit of any material. In preferred embodiments, when the valve is open it only allows passage of hydrogen gas. The valve may open, for example, in response to the generation of about 1 atmosphere of hydrogen gas pressure inside the cassette. Alternatively, the valve may open, for example, in response to the application of two or more atmospheres of hydrogen gas pressure outside the cassette. Those pressures are not limiting and other pressure set points may be used. Thus, in some embodiments the valve is a two-way valve that will allow hydrogen to leave or enter the cassette. In alternative embodiments, the cassette may comprise two one-way valves, a first valve that opens only in response to hydrogen pressure inside the cassette and a second valve that opens only in response to elevated pressure from a hydrogen charging system outside the cassette. In the most preferred embodiments, the valve(s) will not allow passage of liquids, only of gas. It is contemplated within the scope of the invention that any known method of opening and closing the valve(s) may be utilized. Thus, valve opening could occur automatically in response to pressure gradients. Alternatively, electrically controlled valves, such as solenoid operated valves, could open and close in response to signals from an information processing and control system, or valves could be manually operated by engagement with one or more couplings.

Exemplary valves suitable for use are known for controlling gas flow in the nuclear power industry. The gate type design uses spring loaded seal discs that seal tightly at all pressures from 0 psig to maximum rating. When open, the valve permits bi-directional flow with tight sealing in both flow directions. Because of the straight-through flow path with self-cleaning sealing surfaces, internal passages inherently resist any buildup of contamination. Features may include zero leakage to the environment; the absence of any packings, bellows, or diaphragms; a valve rating of ANSI class 150 to 2500; high cycle life with over 100,000 operations in most applications; straight-through flow; and resistance to contamination build-up. The valve body material may comprise stainless steel, carbon steel, AL6V or other ASME Materials. The seats may be carbon. In certain embodiments, position indication switches are available for remote status indication. The valve may comprise socket weld, butt weld or tube extension line connections. Opening and closing of the valve may be controlled by a solenoid operator, constructed of Class H or better materials. Solenoid and switch assemblies may be accessible for removal or maintenance without disturbing the pressure boundary.

Another exemplary valve that may be of use is the latex-free Carhill Valve System designed for use in artificial resuscitation (CORPAK, Wheeling, Ill.). A silicone duckbill valve allows the one-way passage of air. A 99% BFE bi-directional filter prevents cross-contamination of the doped sodium alanate or other hydrogen storage composition.

In another exemplary embodiment, Quick-Connecting Fluid Couplers provide connections in systems that involve the flow of air or gas (Nitto Kohki, Hanover Park, Ill.). A built in automatic open and shut valve provides high flow, easy flow control and an excellent seal. Available valves include Pneumatic HI-CUPLA, Plastic HI-CUPLA ACE, Semiconductor Semicon Cupla, Ultra Small Micro Coupler and Full Blow Cupla. The valve(s) of use in the embodiments are not limited to the examples disclosed herein but may include any valve known in the art that will allow passage of hydrogen gas without leakage of sodium alanate or other hydrogen storing composition. Preferably, the valve(s) will also prevent atmospheric oxygen and/or external water from contaminating the cassette contents.

Smart Chip

In some embodiments of the invention, a smart chip may be incorporated into the cassette housing or placed inside the cassette, for example in contact with the doped sodium alanate or other hydrogen storage composition. An exemplary embodiment of a smart chip would be a flash memory chip as used in digital cameras, computer BIOS chips, CompactFlash, SmartMedia, Memory Stick, PCMCIA Type I and Type II memory cards and memory cards for video game consoles. Flash memory is considered to be a solid state memory device, since it has no moving parts. Flash memory chips may be obtained from a variety of commercial sources, such as 3COM, AVL Technologies Corp., Hewlett-Packard, Hitachi, IBM Corp., NEC, Samsung Corp. and many others. The chip may broadcast a signal that provides information about the cassette operating characteristics to a computer or microprocessor. Alternatively, the chip may be directly connected via wires or other electrical contacts to a computer and/or a transmitter. Information to be provided may include such things as the temperature, hydrogen gas pressure and amount of remaining hydrogen charge in the cassette.

The chip may also signal an operator or an external ordering system when it is time to replace a cassette. In some embodiments where more than one cassette is stored or attached to the vehicle, the smart chip may signal the system to automatically switch or replace a depleted cassette with a charged one. The smart chip may be used as part of a control system to regulate hydrogen generation. For example, the computer may monitor the vehicle fuel needs. The computer, microprocessor or CPU may then regulate the rate of hydrogen release, for example by controlling the degree of heating of the hydrogen storage composition. A feedback system may continually monitor hydrogen pressure inside the cassette and regulate the amount of heat provided to the cassette, thus regulating temperature and hydrogen release.

Hydrogen is released from doped sodium alanate by heating, preferably to 100° C. although in certain embodiments hydrogen release at lower temperatures may be sufficient to satisfy power requirements. In some embodiments, the system may include an accessory bottle of hydrogen to fuel the system and initiate power generation. The electrical power produced during vehicle operation may then be used with an electrical heating element, such as a resistive electrical heater, to raise the internal cassette temperature to the operating temperature. In other embodiments, hydrogen from an accessory bottle or from the cassette may directly power a catalytic heater, as discussed below. Alternatively, the vehicle may comprise an accessory battery or other power source to provide for initial heating of the cassette. In some embodiments of the invention a heating element may be incorporated into the cassette itself. In alternative embodiments a heating element may be built into a Decom™ unit. For example, a retractable heating element may be inserted into the cassette after it has been placed in a cassette receptacle. Any source of heat and any apparatus for heating known in the art may be used to raise the temperature of the alanate composition or other hydrogen storing composition, such as metal hydrides.

In certain embodiments of the invention, cassettes charged with hydrogen may be shipped to any site of utilization, using standard shipping methods and commercial services such as Federal Express, U.S. Postal Service and/or United Parcel Service. A system for ordering, distributing and shipping charged cassettes and returning depleted cassettes is disclosed in U.S. patent application Ser. Nos. 10/099,274 and 10/099,771, filed Mar. 15, 2002. The distribution method is not limiting and any method of providing charged cassettes may be used. In alternative embodiments, charged cassettes may be obtained, for example, at existing service stations, specialized hydrogen refueling stations, distribution centers and/or commercial wholesale or retail outlets. The cassette embodiment is not limiting and it is contemplated that any known system for containing and transporting a solid, hydrogen-generating composition, such as a metal hydride and/or an alanate, may be used.

Heaters

In various embodiments of the invention, part of the hydrogen generated could be provided to a catalytic hydrogen-powered heater. For example, part of the hydrogen could be used to heat the cassette in order to release further hydrogen. Alternatively, a catalytic heater could be incorporated into a hydrogen-powered vehicle to heat the passenger compartment. Any known type of catalytic heater capable of using hydrogen may be used. Catalytic heaters may be obtained from commercial sources, such as Bruest Catalytic Heaters (Branford, Conn.). Catalytic heaters oxidize hydrogen flamelessly, emitting medium to long wave infrared energy. A platinum catalyst forces combustion below the gas ignition point and is capable of generating surface temperatures of up to 1000° F. The temperature is proportional to the rate of reaction, which is in turn dependent on the rate at which hydrogen is provided to the heater. In embodiments involving cassette heating, the rate of hydrogen flow is preferably regulated to maintain the cassette temperature at 100° C. or less.

Other exemplary heaters are available from JP Technologies, Inc. (Raleigh, N.C.). Miniature resistance heaters and Resistance Temperature Detectors (RTD's) are fabricated from thin metallic foils and laminated to thin, heat-resistant plastic substrates. Metal foil may comprise nickel, platinum and/or Balco, with backings and/or encapsulants of Kapton®, glass/epoxy or Mylar. These devices are capable of being bonded onto a variety of intricate shapes, such as the inside or outside surface of cassettes. RTD's may be used in place of or in addition to smart chips to monitor cassette temperature. JP Technologies manufactures thin, metal foil sensors designed for rapid response temperature measurements. The foils used are typically>0.0002″ (0.005 mm) thick and have extremely low thermal inertia. In comparison with standard wire wound RTD's, foil RTD's provide maximum surface exposure and make more intimate contact with surfaces. Heaters and RTD's may be integrated onto a common backing material as one heating and temperature measurement unit.

Another exemplary heater that may be used is made by Hytek (Carson City, Nev.). The HY7110 is a miniature proportionally controlled DC heater with integral thermistor and temperature control circuit. Using an 8-35 volt power supply, the heater is programmable and has a single external resistor for precision microheating applications. The HY7115 heater operates on 3-8 volts of power and is programmable, with a single external resistor for precision microheating.

### EXAMPLES

### Example 1

Cassette Module

An exemplary embodiment of a cassette module is an Hfuel™ A2 cassette (FIG. 7) (FuelSell Technologies, Inc., San Francisco, Calif.). The cassette comprises an outer surface of electrically and thermally insulative, impact and chemically resistant plastic, with a single internal compartment holding about 1 liter of doped sodium alanate or other hydrogen storage composition. In alternative embodiments, the outer casing is comprised of aluminum, ceramic, or an aluminum/ceramic composite. The hydrogen storage composition is surrounded by a series of layered materials, comprising an inner layer of flexible metalized plastic, a middle layer of Kevlar™, and an outer layer of Mylar, surrounded by a small gas (air) space and the outer rigid plastic cover. A hinged handle for inserting and removing the module from a hydrogen utilizing system is present at one end of the cassette. The other end of the cassette interfaces with the hydrogen utilizing system. In preferred embodiments, there is a single opening between the hydrogen storage composition and the outside of the cassette, consisting of a bidirectional, one-way valve for hydrogen movement (see below). When the cassette is inserted into a hydrogen utilizing system or a hydrogen charging system, the valve mates with a coupling on the system.

In preferred embodiments, the cassette also contains a smart chip that may be in contact with the hydrogen storage composition, or may be located between the rigid cover and one or more of the insulating layers discussed above. The smart chip may detect and report conditions inside the cassette to an external information processing and control system. Preferably, the chip may monitor and report such conditions as the temperature of the cassette contents, the hydrogen gas pressure inside the cassette and the amount of hydrogen charge remaining in the cassette. In some embodiments, the smart chip may be part of a feedback control system that monitors the hydrogen gas requirements of the hydrogen utilizing system and the temperature and pressure inside the cassette. For example, an increase in hydrogen demand may result in an increase in heat provided to the cassette contents, resulting in an elevated temperature of the hydrogen storage composition and increased release of hydrogen gas. Depletion of hydrogen fuel from a cassette may result in a signal to an operator to replace or recharge the cassette, or may alternatively result in a signal to an external ordering and delivery system to send a replacement cassette. In other alternatives, a depleted cassette may automatically be replaced with a charged cassette in systems with multiple cassettes. Preferably, the smart chip contains an integrated radiofrequency transmitter that sends information to the information processing and control system without direct electrical connections. Alternatively, the cassette module may contain one or more electrical leads that attach the smart chip and any other internal electrical components (e.g., electrical heating element) to an electrical connector on the hydrogen utilizing system.

### Example 2

Decom™ Unit

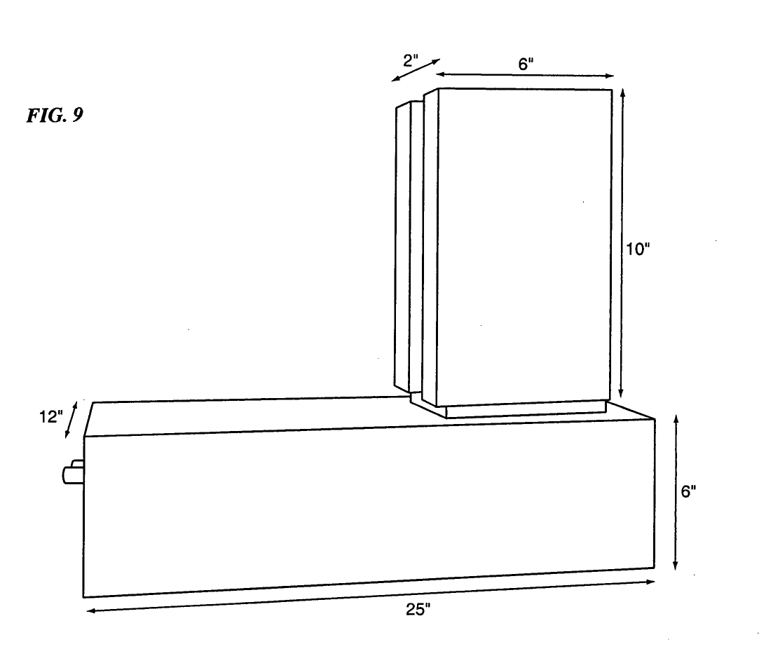

In preferred embodiments, the cassette is designed as a modular unit to be inserted into a hydrogen fuel source. An exemplary embodiment is illustrated in FIG. 9. As indicated, the cassette modules plug into a hydrogen fuel source (Decom™ unit). In this illustrative embodiment, two Hfuel™ cassettes are inserted into a Decom™ system. The Decom™ system may be designed as a fully self-contained electrical power generator, feeding hydrogen gas generated by the cassettes to an internal fuel cell that may generate 6 or 12 volt direct current (DC) electrical power. In other embodiments, the Decom™ unit may feed hydrogen gas to a combustion system, such as an ICE vehicle. In the exemplary embodiment shown in FIG. 9, the Decom™ unit is about 12″ deep, 6″ tall and 25″ wide, while the cassettes are about 2″ deep, 6″ wide and 10″ tall. The skilled artisan will realize that in different embodiments the cassettes may be smaller or larger in size, to accommodate interfacing with various hydrogen utilizing systems.

### Example 3

Components of Decom™ Unit

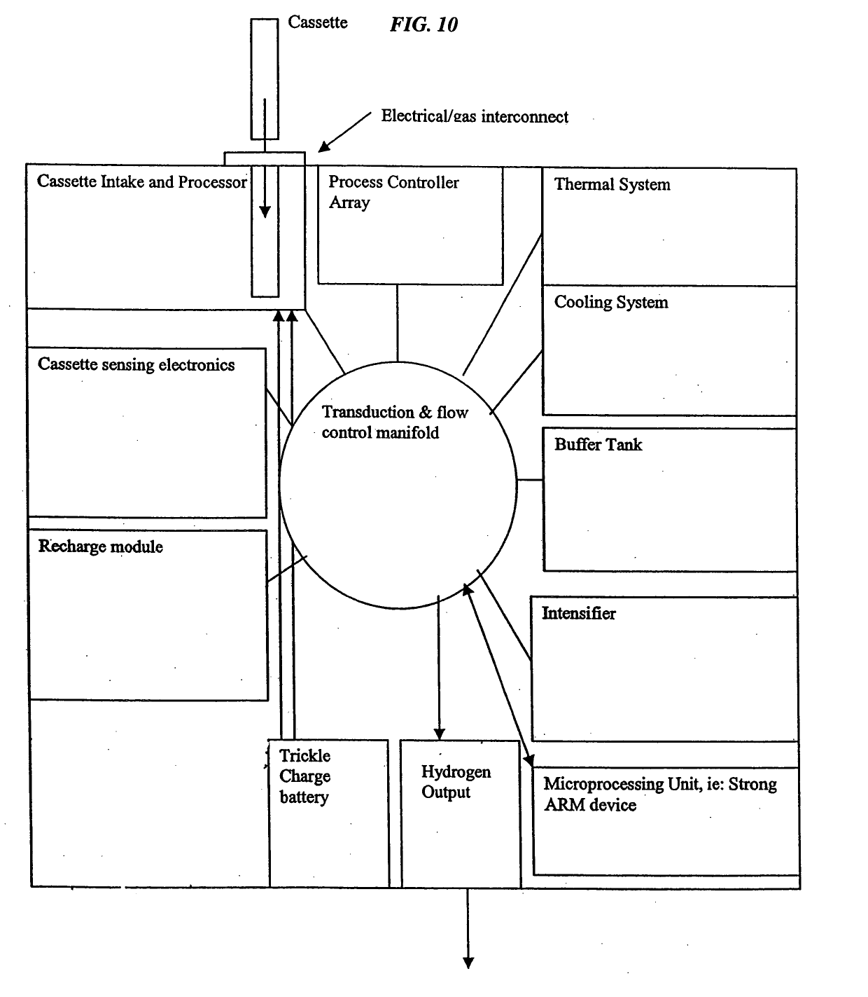

A schematic diagram showing the components of an exemplary hydrogen utilizing system (Decom™ unit) is provided in FIG. 10. A cassette is inserted into a cassette intake and processor element. A cassette sensing module may be internal (e.g., smart chip) or external to the cassette. Hydrogen may be provided to a variety of hydrogen utilizing elements, such as an ICE vehicle

In certain embodiments, a recharge module may be present that recharges the cassette in place by providing hydrogen gas under high pressure. Alternatively, cassettes may simply be removed and replaced with fresh cassettes. Thus, the recharge module may be an optional component of the system. Where cassettes are recharged while attached to the system, the cassette may generate excess heat. Thus, a cooling system may be present to remove excess heat from the system.

In certain embodiments, release of hydrogen requires heating of a hydrogen storage composition, such as a doped alanate or a metal hydride. In alternative embodiments, electrical heating elements may be built into the cassette (for example, HY7110 or HY7115 DC heaters from Hytek, Carson City, Nev.). In such case, electrical leads may be provided from a trickle charge backup battery to heat the cassette. Alternatively, heating elements contained within the Decom™ unit may be inserted into the cassette to provide heat. In this case, the Decom™ unit may comprise a thermal module. A backup hydrogen storage tank (buffer tank) may also be included to provide a hydrogen supply to the vehicle while the hydrogen storage composition is being heated. In certain embodiments, one or more venting valves may be included to release excessive hydrogen pressure from the system.

In certain embodiments, the Decom™ unit may comprise an intensifier element. An intensifier may, for example, generate infrared, laser, ultrasonic, vibration, microwave, terrahertz or other electromagnetic frequency radiation to speed up, slow down or otherwise alter the kinetics of hydrogen absorption or release or other processes within the Decom™ unit. The various processes occurring within the Decom™ unit may be integrated through a transduction and flow control manifold coupled to a process controller array. In various embodiments, the functions of the hydrogen utilizing system may be regulated by an information processing and control system (microprocessing unit, for example a Strong ARM device, Digi-Key, Thief River Falls, Minn.). The skilled artisan will realize that the disclosed embodiment is illustrative only and that other hydrogen utilizing system, comprising some or all of the elements discussed above and/or comprising additional elements that are known in the art may be used in the claimed methods, apparatus and compositions.

### Example 4

Cassette Heaters

In certain embodiments, cassette heating elements are part of a hydrogen utilizing system and are inserted into spaces within the cassette module. A set of thermal vanes may be attached to a thermal module in a Decom™ unit and fit into corresponding slots in the cassette. The heating elements may be in the form of thermal prongs and may insert into corresponding holes in the cassette base. Heat may be generated by any method known in the art, such as electrical resistive heaters or catalytic oxidation of hydrogen. In certain embodiments, heat generated by an internal combustion engine may be used to heat the contents of the cassette. In an exemplary embodiment the heating elements, such as resistive heaters, may be incorporated into the cassette housing. A non-limiting example of heaters suitable for such use include miniature resistance heaters (JP Technologies, Inc., Raleigh, N.C.) or HY 7110 or HY7115 heaters (Hytek, Carson City, Nev.). Such heaters may operate on DC electrical current, provided from a trickle charge battery or a fuel cell.

In another non-limiting example of a cassette heating system, the cassette is designed with thermal induction recesses running along the sides of the cassette. The recesses are in direct contact with thermal vanes in the Decom™ unit that are attached to a thermal system. In contrast to the rest of the cassette outer covering, the thermal induction recesses are composed of highly thermal conductive materials in order to facilitate heat transfer from the heating elements to the hydrogen storage composition. In some embodiments, additional heat transfer elements, such as vanes or tubes of conductive material, may extend from the thermal induction recesses through the hydrogen storage composition. In all embodiments involving external heating elements, the layers of the cassette material are arranged so that there are minimal or no thermal barriers between the heating element and the hydrogen storage composition. For example, where a reflective metalized plastic layer is present, it would only line those portions of the hydrogen storage composition that are not in direct contact with an external heating element. Similarly, in preferred embodiments there would be minimal or no gas (air) space between the heating element and the hydrogen storage composition.

### Example 5

Hydrogen Valve

An exemplary embodiment of a hydrogen valve of use in the disclosed apparatus and methods is shown in FIG. 8. The valve is a switchable bi-directional one-way valve. When the valve is switched in one direction, it allows hydrogen gas to pass from the cassette module to a hydrogen utilizing system, such as an ICE vehicle. When the valve is switched in the other direction, it allows the cassette to be charged with pressurized hydrogen gas from an external supply. In either switching mode, gas may flow in one direction only. The valve is designed to allow movement of gas, but to prevent the movement of water or other liquids. A variety of water impermeable gas valves are known in the art. For example, such a valve might comprise a selectively permeable membrane that allows passage of gas but not water, for example a GORE-TEX® (W. L. Gore and Associates, Inc., Newark, Del.) or other membrane. In preferred embodiments, the valve direction is determined by the coupling to which it is attached. When the cassette is inserted into a hydrogen utilizing system, the coupling turns a collar that allows hydrogen gas to exit the cassette. When the cassette is attached to a hydrogen charging system, the coupling switches the valve to the other direction, allowing hydrogen gas to enter the cassette and recharge the hydrogen storage composition. Various derivatives of the valve are contemplated, including embodiments utilizing, a male to female or female to male connection or a locking collar that can slide up or down, depending on the coupling attachment. Alternatively, the locking collar may be fixed by a surface mount.

### Example 6

ICE Vehicle Conversion

Hydrogen gas is almost no different in octane from gasoline. When a spark is provided to a mixture of hydrogen gas and oxygen, the result is combustion. Thus, the same engine design that works using gasoline as a fuel can also be fueled by hydrogen. To convert an ICE vehicle to run on hydrogen gas, the gasoline tank and fuel pump are removed. A hydrogen fuel source, such as a Decom™ unit is installed. In an exemplary embodiment, the Decom™ unit is installed in the trunk of the vehicle and a hydrogen gas line is installed from the Decom unit in the trunk to the gas manifold, which would typically be mounted on or near the engine block. In alternative embodiments, the Decom™ unit or other hydrogen fuel source may be mounted in the space vacated by the fuel tank. In such embodiments, a hydrogen gas line and port, to allow recharging of the fuel source by attachment to an external source of high-pressure, high purity hydrogen gas may be installed, for example with the port for connection to the external gas line located where the gasoline filling port was located on the vehicle. However, where a Decom™ unit is used that may be refueled by insertion of recharged FuelCassettes™ into the unit, the location in the trunk would allow for easier access and replacement of spent FuelCassettes™.

Regardless of location, a gas line is installed to connect the hydrogen fuel source with the gas manifold. The gas manifold is installed in the engine compartment, with flexible tubing to attach to the HIPAs. The spark plugs are removed and replaced with HIPAs and the HIPAs are connected to the manifold to provide hydrogen gas to the engine. The HIPAs are also connected to the electronic ignition system of the vehicle, with specially adapted electrical connectors designed to attach to the HIPAs. In an exemplary embodiment, air is provided to the engine through an existing fuel injection system, which can mix the air with hydrogen in the engine chamber. In alternative embodiments, the hydrogen and air may also be mixed with water vapor, which would produce more expanding power during the combustion of the hydrogen. Hydrogen is 10 times faster burning than gasoline so the engine peak horsepower would be at a higher revolution per minute (rpm). Timing for the opening and closing of valves and ignition via the spark has to be very precise at this higher speed. This precision is provided by a CPU, downloaded tables and sensors in the HIPAs.

In an exemplary embodiment, a minicomputer comprising a CPU, EPROM and modem is installed. The modem is connected to an external phone line and a set of control programs and data tables, specific for the particular make, model and year of vehicle, is downloaded into the EPROM. The downloaded control programs and data tables provide accurate timing and engine setting information for each model car to reduce backfires and pre-ignitions from inaccurate timings, a serious problem with current methods of ICE vehicle conversion.

The spark timing is advanced to trigger ignition sooner, to compensate for the quicker burning of hydrogen compared to gasoline. Because hydrogen gas has much less power per unit volume, the compression ratio of the cylinders is increased. Optionally, the crankshaft may be replaced in order to increase the pressure in the cylinder by having a more aggressive crankshaft that pushes the piston up higher into the cylinder and compresses the contents more. Alternatively, the engine may be supercharged or turbocharged. Such methods force a high pressure mixture of hydrogen and air into the engine.

A timing wheel and sensor is attached to the front of the crankshaft. The timing sensor, HIPA sensors, manifold sensors and any other sensors are connected to the CPU. The CPU is connected to control subsystems to control operation of the Decom™, gas manifold, HIPAs, ignition system and other vehicle components. The vehicle is provided with hydrogen fuel, either in the form of charged FuelCassettes™ or by connection to a high pressure hydrogen gas line. After charging, the vehicle is ready for operation.

### Example 7

Method for Ordering, Distributing and Shipping Cassettes

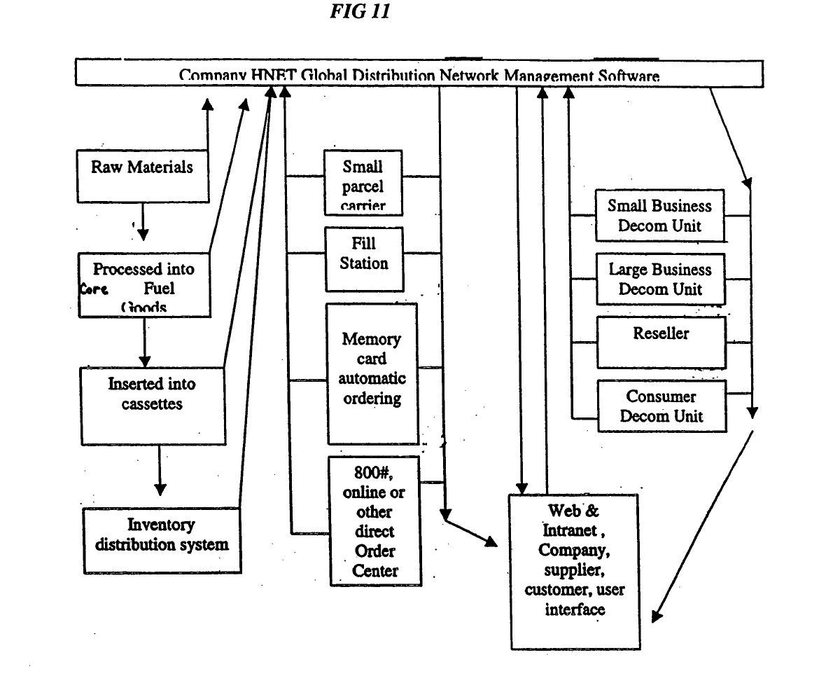

FIG. 11 illustrates an exemplary system for ordering, distributing and shipping charged cassettes and recovering discharged cassettes, for embodiments wherein the discharged cassettes are not recharged while they are attached to a hydrogen utilizing system. For example, cassettes may be used in remote locations where there is no available high pressure hydrogen gas source. In such case, it may be preferred to ship fully charged cassettes to the remote location and to return discharged cassettes to a central facility. As indicated in FIG. 11, an H-Net™ Global Distribution Network Management Software system may control one or more aspects of cassette distribution. In certain embodiments, a smart chip or other monitoring device inserted into or attached to a cassette may detect the discharge status of the cassette. When the cassette reaches a predetermined level of remaining hydrogen charge, the smart chip may signal the Management system to ship a replacement cassette to the use location. The Management system may interface with an inventory distribution system to place an order for one or more cassettes. The Management system may also place an order for pickup and shipment of replacement cassette(s) with a small parcel carrier. The delivery of the replacement cassette(s) may also be monitored by the Management system.

The H-Net™ global distribution network management software system may receive input from a variety of sources, such as information related to the fabrication or creation of new sets of each fuel cassettes. Information related to raw materials and the fabrication of raw materials into core fuel goods may be conveyed to controller software. Further, management software may receive information related to the core material inserted into cassettes and ready for distribution in inventory. In this manner, management software is able to retain information related to sets of fuel cassettes in inventory and ready for use by consumers.

The Hfuel™ cassettes in inventory may be consumed by consumers through various channels. Particularly, consumers may order small parcel delivery of fuel cassettes. Additionally, consumers may order or obtain fuel cassettes via conventional filling stations. In certain embodiments, the present invention enables consumers to configure a fuel cassette and/or a Decom™ unit to automatically electronically convey ordering information to the management software or a local server, which may process fuel orders. In this manner, the consumer does not need to explicitly order new Hfuel™ cassettes when existing inventories have been exhausted. Upon consumption of available fuel cassette capacity, and if so configured for automatic ordering, the Hfuel™ cassette and/or Decom™ unit can automatically convey ordering information to management software via a memory/telemetry circuit and/or microprocessing unit. Additionally, consumers may explicitly order fuel cassettes via conventional 800 telephone numbers, Internet accessible websites, or other conventional direct order techniques. Additionally, management software may receive information from Decom™ units deployed in various locations in a distribution network. For example, small business or large business Decom™ units may convey fuel usage and requirements information to management software. Also, reseller and consumer Decom™ units may also convey similar information to management software. Finally, management software may also receive and/or convey information between web and Internet data sources or other customer or supplier information sources.

In certain embodiments of the invention, cassettes used to power vehicles may come in the form of a rack and/or pallet containing multiple cassettes. In preferred embodiments, as each cassette in the rack and/or pallet is discharged, the cassettes are automatically switched so that the discharged cassette is replaced with a charged cassette. Preferably, a monitor reporting to a CPU or other computer informs the operator as to the amount of hydrogen fuel left in the rack and/or pallet. When the fuel has been partially or fully depleted, either individual cassettes may be replaced or, more preferably, the entire rack and/or pallet may be replaced. In alternative embodiments, the vehicle may be recharged with fuel at a hydrogen fueling station that provides relatively pure hydrogen gas at high pressure. The hydrogen gas is fed to the discharged cassettes and recharges the cassettes. In order to provide recharging in a moderate amount of time, it may be desirable to provide a cassette cooling system in the vehicle to remove excess heat generated during hydrogen charging. In alternative embodiments, it is envisioned that additional hydrogen fuel could be obtained at regional or local hydrogen fueling stations, either by switching discharged cassettes for charged ones or by recharging discharged cassettes on site. Preferably, such stations would have both replacement cassettes, racks and/or pallets and high pressure hydrogen gas charging lines, so that the consumer may choose between replacing discharged cassettes or recharging them.

All of the METHODS, KITS and APPARATUS disclosed and claimed herein can be made and executed without undue experimentation in light of the present disclosure. While the methods, kits and apparatus of this invention have been described in terms of preferred embodiments, it will be apparent to those of skill in the art that variations may be applied without departing from the concept, spirit and scope of the invention. More specifically, it will be apparent that certain agents that are equivalent to those disclosed herein may be substituted while the same or similar results would be achieved. All such similar substitutes and modifications apparent to those skilled in the art are deemed to be within the spirit, scope and concept of the invention as defined by the appended claims.

What is claimed is:

1. A apparatus comprising:
a) a set of HIPAs (hydrogen injection port adaptors);
b) a source of hydrogen fuel; and
c) a gas manifold to connect the HIPAs to the hydrogen fuel source.

2. The apparatus of claim 1, further comprising an information processing and control system to regulate the flow of hydrogen to the HIPAs and the timing of hydrogen ignition.

3. The apparatus of claim 1, further comprising a mechanical timing wheel or belt.

4. The apparatus of claim 3, wherein the timing wheel or belt is tensionable or tunable to synchronize the timing of hydrogen ignition.

5. The apparatus of claim 1, wherein hydrogen fuel is provided from a source selected from the group consisting of liquified hydrogen, compressed hydrogen gas, a metal hydride, a hydride slurry, doped sodium alanate, a borohydride, nanoparticles, carbon nanotubes, buckminsterfullerenes, a hydrocarbon reformer or glass microspheres.

6. The apparatus of claim 1, wherein hydrogen gas flows within each HIPA from a hydrogen input tap, through a hydrogen flow adjustment valve to a hydrogen channel and out through a spark Venturi.

7. The apparatus of claim 1, wherein each HIPA comprises one or more baffles in a hydrogen channel.

8. The apparatus of claim 1, wherein each HIPA comprises a hydrogen channel sensor.

9. The apparatus of claim 1, wherein each HIPA comprises a spark area sensor.

10. The apparatus of claim 1, wherein the gas manifold comprises a staggered pump.

11. The apparatus of claim 1, wherein the gas manifold comprises one or more sensing adjusters.

12. The apparatus of claim 1, wherein the gas manifold comprises a manifold block processing hub.

13. The apparatus of claim 1, wherein the gas manifold comprises one or more gas flow and temperature sensors.

14. The apparatus of claim 1, wherein the gas manifold comprises one or more adjustment solenoids to control movement of gas from the manifold to the HIPAs.

15. A method for converting an ICE engine to run on hydrogen fuel comprising:
a) replacing the spark plugs with HIPAs;
b) installing a source of hydrogen fuel;
c) installing a gas manifold to connect the HIPAs to the hydrogen fuel source; and
d) connecting the HIPAs to an electrical ignition system.

16. The method of claim 15, wherein the electrical ignition system comprises an information processing and control system to regulate the flow of hydrogen to the HIPAs and the timing of hydrogen ignition.

17. The method of claim 16, wherein the information processing and control system comprises an EPROM (erasable programmable read only memory).

18. The method of claim 17, wherein the EPROM is operably coupled to a modem chip.

19. The method of claim 18, further comprising downloading a program into the EPROM by telephone to control the engine function.

20. The method of claim 19, wherein the program is designed to optimize engine function for the make and model of vehicle comprising the engine.

21. A kit for converting internal combustion engine (ICE) vehicles to hydrogen fuel comprising:
a) a set of HIPAs; and
b) a gas manifold to connect the HIPAs to a hydrogen fuel source; and
c) a source of hydrogen fuel.

22. A hydrogen injection port adaptor comprising:
a) a hydrogen channel;
b) one or more baffles in the hydrogen channel;
c) a spark generator; and
d) one or more sensors.

23. The hydrogen injection port adaptor of claim 22, further comprising a hydrogen flow adjustment valve.

24. The The hydrogen injection port adaptor of claim 23, further comprising a spark Venturi.

25. The hydrogen injection port adaptor of claim 22, further comprising a hydrogen channel sensor.

26. The hydrogen injection port adaptor of claim 22, further comprising a spark area sensor.

27. The apparatus of claim 2, wherein the information processing and control system comprises a neuro, fuzzy, or neuro-fuzzy controller.

28. The apparatus of claim 27, wherein the information processing and control system comprises a neural net controller.

29. The method of claim 20, further comprising updating the operating parameters of the program to improve engine performance.

30. The method of claim 29, wherein the operating parameters are updated by provision of correction values.

31. The method of claim 30, wherein the correction values are calculated based on engine performance output values.
